(19) United States
(12) Patent Application Publication
(10) Pub. No.: US 2005/0120572 A1
(43) Pub. Date: Jun. 9, 2005

(54) Hinge-mounted door leveling devices and assemblies

(76) Inventor: Jack Valenti, Mastic, NY (US)

Correspondence Address: Galgano & Burke;Suite 35, 300 Rabro Drive, Hauppauge, NY, 11788, US

(21) Appl. No.: 10/729,561

(22) Filed: Dec. 5, 2003

(51) Int. Cl. G01C 9/00

(52) U.S. Cl. 33/371

(57) ABSTRACT

Devices and assemblies for facilitating the level installation of doors, and are particularly useful for the installation of pre-hung doors.

The present invention relates to devices and assemblies which facilitate the level installation of doors, particularly pre-hung doors.

### BACKGROUND OF THE INVENTION

The installation of doors, particularly interior doors is common during new construction and remodeling of existing building space. Doors are typically hung by carpenters or other workmen. In order for doors to function properly after installation, it is important that the doors are hung in a level manner. While doors can be and have often been installed by positioning hinges into an existing doorway, it is now common for many types of doors to be sold with a frame to which the door is already attached. These doors are commonly referred to as “pre-hung” doors. Pre-hung doors are generally recognized as being easier for the workmen to install at the construction site. Typical installation of a pre-hung door requires one or more people to position the frame of the door within the pre-existing doorway structure, utilize a level to position the door in a level position and then attach the frame to the existing doorway, for example with a nail gun, screw gun, or fasteners and tools. Those skilled in the art will appreciate that different construction locations will require the replacement of fasteners at different points along the door frame. Therefore, it is most desirable to provide the widest range of available sites for placing such fasteners. Therefore, it is undesirable to cover frames with leveling devices which would impede position fasteners in those locations in the frame.

Some doors have right handed hinges while other doors have left-handed hinges, when considered from the same perspective. It would, therefore, be desirable to provide a device which facilitates the level installation of a door regardless of whether the door has right-handed hinges or left-handed hinges.

It would also be desirable to provide devices and assemblies for the level installation of doors wherein the devices and assemblies are relatively easy and inexpensive to manufacture.

### SUMMARY OF THE INVENTION

The various embodiments of the present invention provides devices and assemblies for the level installation of doors. The embodiments of the present invention can be used with pre-hung doors and are particularly useful for the installation of pre-hung doors.

One preferred embodiment of the present invention comprises a body having a generally U-shaped channel on one side and at least one, and preferably two recesses on the opposite side. An attaching member is also provided for securing a common level within the generally U-shaped channel. According to this embodiment of the present invention, the recesses on the back side of the device is dimensioned to slide over a common door hinge and to sit relatively snugly. Preferably, at least two such devices are placed over at least two hinges of a door. A common level is then positioned within the U-shaped channel and secured to the channel with an attaching member. A preferred attaching member of the present invention comprises a thread rod having a knob which is simply tightened onto the level after the level is placed in the U-shaped channel. Once the level is secured to the hinges, the door installation can proceed without requiring any hands to hold the level. The devices used to secure the level to the hinges can be shorter than the length of the hinges and therefore do not impede placement of fasteners at any desired locations along the door frame. The devices of this embodiment of the present invention are particularly easy to use and inexpensive to manufacture.

### BRIEF DESCRIPTION OF THE DRAWINGS

FIG. 1 is a perspective view of one embodiment of the present invention.

FIG. 2 is a bottom view of the of the embodiment shown in FIG. 1.

FIG. 3 is a rear elevational view of the embodiment shown in FIG. 1.

FIG. 4 is a side elevational view of the embodiment shown in FIG. 1.

FIG. 5 illustrates two devices of the present invention positioned on a door.

FIG. 5A is a close-up view of one of the devices of the present invention located on a hinge.

FIG. 6 illustrates an assembly of the present invention.

FIGS. 7 and 7A illustrates an alternative embodiment of the present invention wherein a level comprises hinged-receiving slots.

FIG. 8 illustrates an alternative embodiment of the present invention comprising a level designed for releasable attachment to a single hinge at one time.

### DETAILED DESCRIPTION OF THE PREFERRED EMBODIMENTS

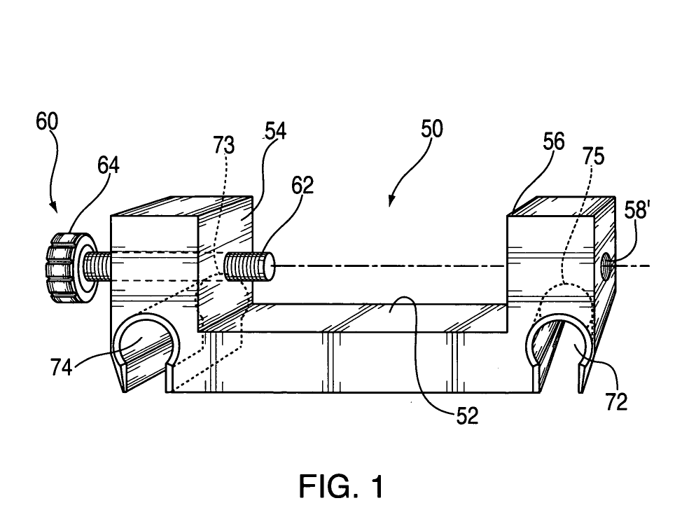

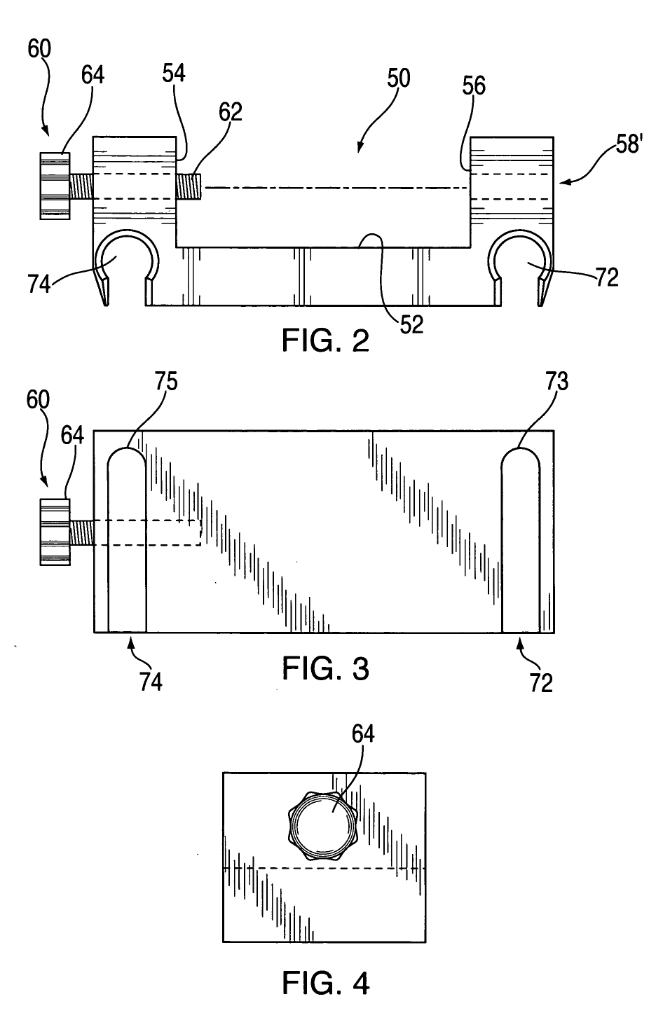

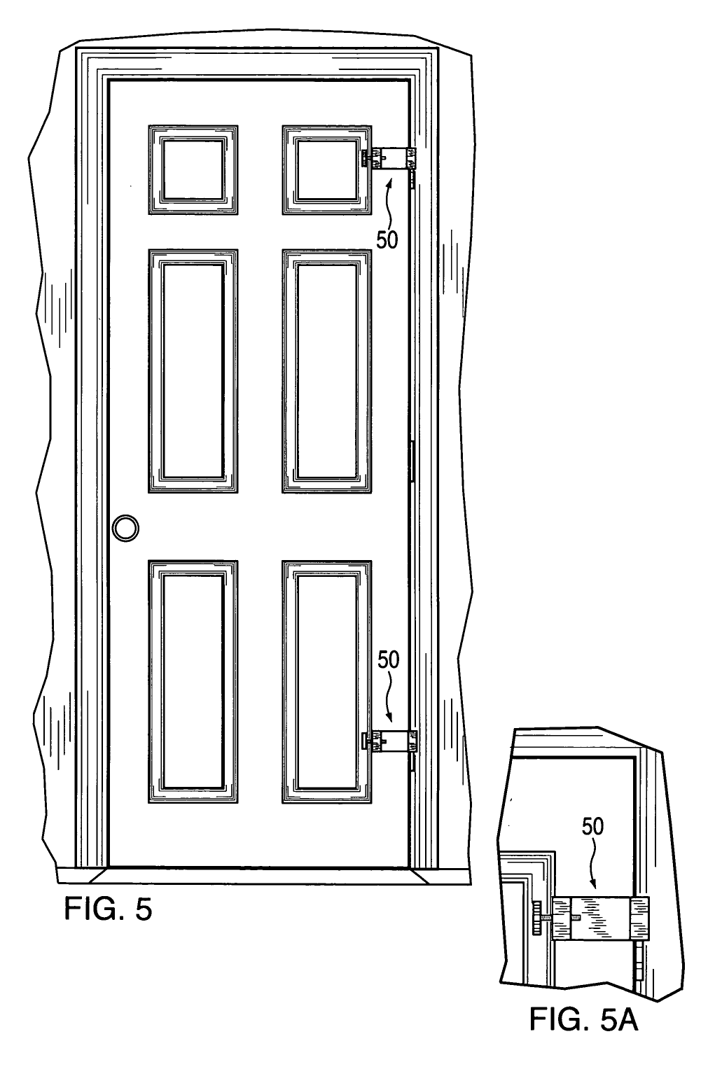

One preferred embodiment of the present invention is shown in FIGS. 1-4 comprises a device 50 having a U-shaped channel defined by a base 52, left sidewall 54 and right sidewall 56. The general U-shaped channel is dimensioned to receive a common level. Since levels can come in different sizes in order to secure a level within generally U-shaped channel an attachment member 60 comprising a threaded rod 62 and knob 64. Threaded rod 62 passes through a threaded bore of side wall 54 for reasons which will be explained in further detail blow. A threaded through hole 58′ is similarly located in right side wall 56.

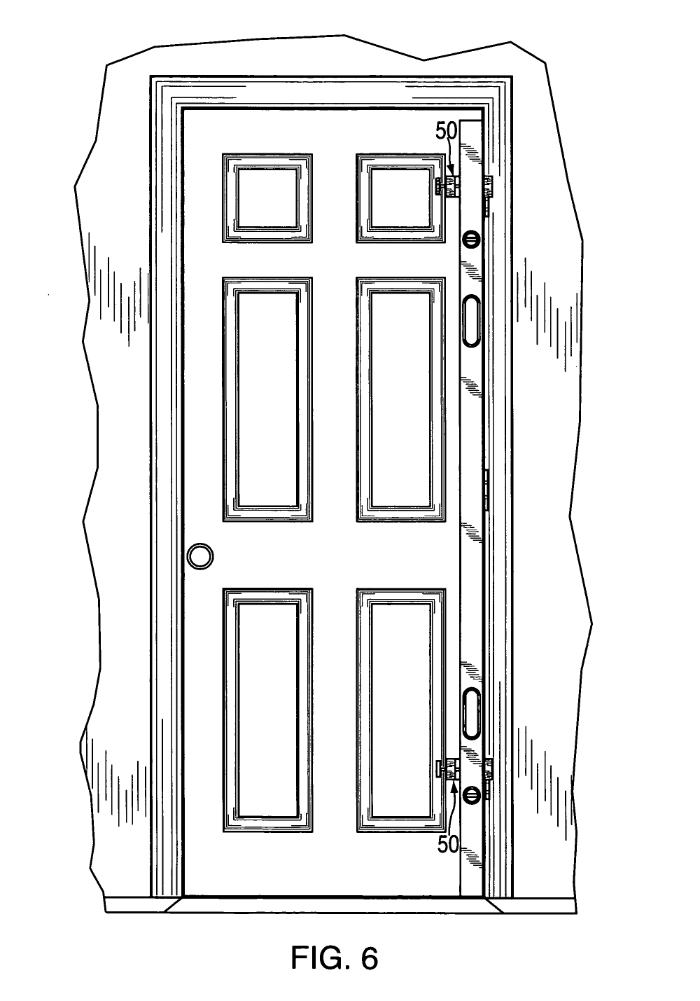

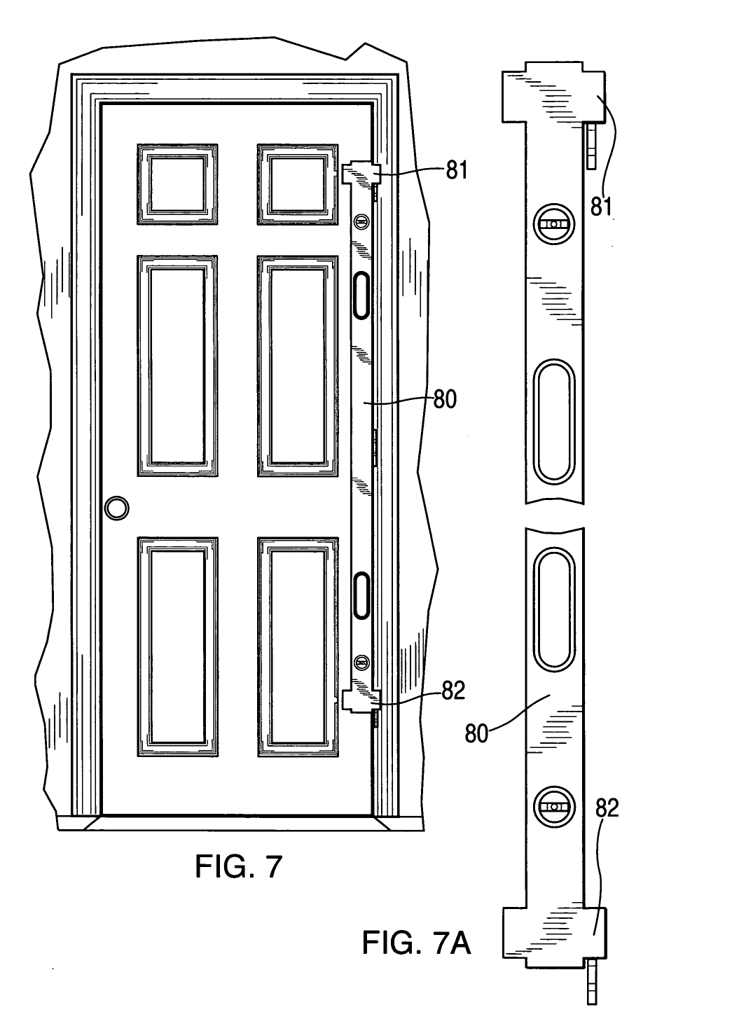

According to this preferred embodiment of the present invention, the back side of device 50, i.e., the side opposite the general U-shaped channel, comprises to recesses 72 and 74. Each of these recesses has a generally key-hole shape and extends along a substantial segment of the height of the device, terminating in an end wall 73. Recess 72 terminates at end wall 73 while recess 74 terminates at end wall 75. Each of these recesses is designed to allow device 50 to be slid over a door hinge and to fit snugly on the hinge in the manner illustrated in FIGS. 5-6.

In order to use the device of the present invention, the device is simply slid over a hinge of a door to be hung wherein the hinge is placed in a recess on the side opposite the general U-shaped channel. While the preferred embodiment has two recesses 72, 74, it is also within the scope of the present invention to have a single recess. It is also possible to have recesses of different sizes and shapes without departing from the scope of the present invention. As illustrated in FIG. 5, it is preferable to have at least two devices positioned over hinges on a door. FIG. 5A is a close up view of a clamping device positioned on a hinge. Once the devices are positioned on hinges, a level is then positioned within the devices and secured in place by rotating knob 64 which causes threaded rod 62 to advance and clamp the level in place as shown in FIG. 6.

FIGS. 7 and 7A illustrate an alternative embodiment of the present invention wherein a level is integrally formed with recesses designed to receive two, spaced hinges of a door. According to this embodiment of the present invention, the level 80 is integrally formed with a first flange 81 and a second flange 82 comprising recesses designed to receive spaced apart hinges, respectively. This embodiment of the present invention eliminates the need for separate devices and the connection of the separate devices to a level. The illustrated flange advantageously extend outwardly from both sides of the level to facilitate attachment to right handed and left handed doors.

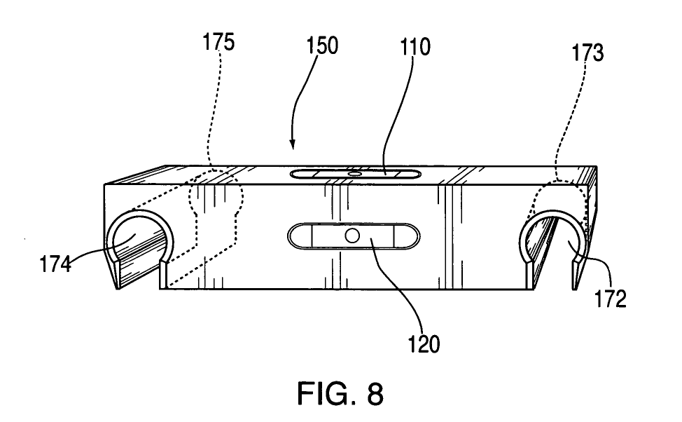

FIG. 8 illustrates a still further embodiment of the present invention wherein a device 150 is generally in the form of a block and comprises one or more levels. In the illustrated embodiment, device 150 comprises two levels readily visible from separate surfaces of device 150. This embodiment of the present invention comprises a pair of slots 172 and 174 comprising terminal and ______ 173 and 175, respectively. As in the embodiments described above, these slots are designed to allow device 150 to be slid over hinges. In this illustrated embodiment, the surface of device 150 opposite the recesses comprises a level 110 while the surface adjacent the openings of the recesses comprises another level 120. While this embodiment of the present invention comprises two levels, it is within the scope of the present invention to provide one or more levels which can be visible from one or more angles. For example, a single level can be provided which is visible from above, below, straight on, and from either side of the device.

When the level is securely connected to the hinges, the door can be readily moved into position and secured without concern for holding the level.

Therefore, one aspect of the present invention comprises a device for installation of a door comprising: means for releasably attaching a level; and means for releasably connecting said attaching means to a hinge on a door.

Another aspect of the present invention comprises a device for facilitating installation of a pre-hung door comprising: a generally U-shaped block comprising at least one notch on either side of the block extending through most of the block and dimensioned to slide over a hinge of a door; and a threaded rod extending through one portion of the U-shaped block comprising a knob which facilitates the advancement and retraction of the rod for releasably securing a common level to the block.

Another aspect of the present invention comprises an assembly for installation of a pre-hung door comprising: a level; and means for releasably attaching said level directly to a hinge on a pre-hung door.

1. A device for installation of a door comprising:
means for releasably attaching a level; and
means of releasably connecting said attaching means to a hinge on a door.

2. A device for installation of a door according to claim 1 wherein said connecting means connects said attaching means directly to a hinge.

3. A device for installation of a door according to claim 2 wherein said attaching means comprises a generally U-shaped channel.

4. A device for installation of a door according to claim 3 wherein said attaching means comprises a rotatable threaded rod.

5. A device for installation of a door according to claim 2 wherein said channel is formed in a body and wherein said connecting means comprises a recess formed in said body.

6. A device for installation of a door according to claim 5 wherein said connecting means comprises a plurality of recesses to facilitate attachment of a level alternatively to a right-handed or left-handed hinge.

7. A device for installation of a door according to claim 1 wherein said attaching means comprises a generally U-shaped channel.

8. A device for installation of a door according to claim 7 wherein said attaching means comprises a rotatable threaded rod.

9. A device for installation of a door according to claim 1 wherein said channel is formed in a body and wherein said connecting means comprises a recess formed in said body.

10. A device for installation of a door according to claim 9 wherein said connecting means comprises a plurality of recesses to facilitate attachment of a level alternatively to a right-handed or left-handed hinge.

11. A device for installation of a door according to claim 2 wherein said attaching means comprises a clamp.

12. A device for installation of a door according to claim 11 wherein said connecting means connects said attaching means directly to a hinge.

13. A device for facilitating installation of a pre-hung door comprising:
a generally U-shaped block comprising at least one notch on either side of the block extending through a portion of the block and dimensioned to slide over a hinge of a door; and
a threaded rod extending through one portion of the U-shaped block, comprising a knob attached proximate one end, for releasably securing a level to the block.

14. A device for facilitating installation of a pre-hung door according to claim 13 wherein said notch is dimensioned to fit snugly on a hinge of the door.

15. A device for facilitating installation of a pre-hung door according to claim 13 wherein a generally U-shaped block comprises at least one notch on different portions of said block extending through a portion of the block and dimensioned to slide over a hinge of a door.

16. A device for facilitating installation of a pre-hung door according to claim 13 wherein a thread rod extending through one portion of the U-shaped block further comprising a knob attached to said threaded rod for releasably securing a level to the block.

17. An assembly for installation of a pre-hung door comprising:
a level; and
means for releasably attaching said level directly to a hinge on a pre-hung door.

18. An assembly for installation of a pre-hung door according to claim 17 comprising means for releasably attaching said level to at least two hinges.

19. An assembly for installation of a pre-hung door according to claim 17 wherein said attaching means comprises at least one generally U-shaped channel.

20. An assembly for installation of a pre-hung door according to claim 19 wherein said attaching means comprises at least one threaded rod.

21. An assembly for installation of a pre-hung door according to claim 17 wherein said attaching means comprises a plurality of separate U-shaped channels.

22. An assembly for installation of a pre-hung door according to claim 21 wherein said attaching means comprises at least two threaded rods.

23. An assembly for installation of a pre-hung door according to claim 21 wherein at least one of said channels is formed in a body comprising at least one recess dimensioned to slide over a hinge of a pre-hung door.

24. An assembly for installation of a pre-hung door according to claim 21 wherein each of said channels is formed in a body comprising at least one recess dimensioned to slide over a hinge of a pre-hung door.

25. An assembly for installation of a pre-hung door according to claim 21 wherein at least two of said channels are formed in separate bodies, each of said bodies comprising at least one recess dimensioned to slide snugly over a hinge on a pre-hung door.

26. An assembly for installation of a pre-hung door according to claim 25 wherein each of said bodies comprises a plurality of recesses dimensioned to slide snugly over a hinge on a pre-hung door.

27. A device for facilitating installation of a pre-hung door comprising:
a level; and
means for releasably attaching said level directly to a hinge on a pre-hung door.

28. A device for facilitating installation of a pre-hung door according to claim 27 wherein said attaching means is integrally formed with said level.

29. A device for facilitating installation of a pre-hung door according to claim 28 wherein said attaching means comprises at least one recess dimensioned to slide over a hinge of a pre-hung door.

30. A device for facilitating installation of a pre-hung door according to claim 28 wherein said attaching means realeasably attaches said level to at least two hinges at the same time.
